(19) United States
(12) Patent Application Publication
(10) Pub. No.: US 2011/0149045 A1
(43) Pub. Date: Jun. 23, 2011

(54) CAMERA AND METHOD FOR CONTROLLING A CAMERA

(76) Inventors: Alexander Wuerz-Wessel, Stuttgart (DE); Jens Schick, Herrenberg (DE)

(21) Appl. No.: 12/988,562

(22) PCT Filed: Apr. 28, 2009
(86) PCT No.: PCT/EP2009/055113

§ 371 Date: Feb. 1, 2011

(30) Foreign Application Priority Data
Apr. 29, 2008 (DE) 10 2008 001 451.6

(51) Int. Cl. H04N 13/02

(52) U.S. Cl. 348/49; 348/E13.074

(57) ABSTRACT

The camera has a main sensor for capturing a first image of a scene having at least one object. A lens is provided for the main sensor. At least one auxiliary sensor, which is situated at a distance from the main sensor, is used to capture a second image of the scene at a viewing angle different from that of the main sensor. An evaluation device stereoscopically determines a distance to the at least one object on the basis of the first and second images. An autofocus system sets a focus of the lens in response to the determined distance.

### FIELD OF THE INVENTION

The present invention relates to a camera. The camera may be suitable for taking individual images or moving pictures. The present invention also relates to a method for controlling a camera.

### BACKGROUND INFORMATION

A scene having one or several objects may be photographed using a camera. To this end a lens of the camera is set to a suitable focus, in order to ensure that the scene appears sharply. Typically, for this purpose one of the objects is selected and the focus is set to that object.

The focus may be set manually. High-end cameras capture the scene through the lens using a special stereo sensor. The focal length of the lens is modified by the photographer until phases captured stereoscopically are adjusted in an image section.

Active methods for setting the focus utilize the measurement of the distance to the selected object with the aid of an ultrasound sensor or a projection and measurement of stripe patterns on objects.

Facial recognition systems may also be implemented in cameras. The positions of faces in a captured image are ascertained with the aid of the facial recognition system. The methods for setting the focus are then applied to a portion of the picture that has been recognized as a face. Such a camera is limited to photographing people; furthermore, there are problems if the face is partially covered by clothing, a beard, etc.

### SUMMARY OF THE INVENTION

The present invention relates to a camera. The camera has a main sensor for capturing a first image of a scene having at least one object. A lens is provided for the main sensor. At least one auxiliary sensor located at a distance from the main sensor is used to capture a second image of the scene from a viewing angle different from that of the main sensor. An evaluation device stereoscopically determines a distance to the at least one object, based on the first and second image. An autofocus system sets a focus of the lens in response to the determined distance. Alternatively or additionally, an exposure setting device sets the exposure of the main sensor according to the second captured image.

According to the present invention the following steps are performed to control a camera:

parallel capturing of at least one first image of a scene with the aid of a main sensor and at least one second image of the scene with the aid of at least one auxiliary sensor from a viewing angle different from that of the main sensor;

associating one of the image objects in the first and second image with an object used for setting the focus;

determining a distance to the object on the basis of a shift of the associated image object in the first image relative to the second image; and

setting the focus of a lens for the main sensor in response to the determined distance, and/or setting the exposure of the main sensor according to the second captured image.

The camera's autofocus system functions regardless of the type of object. Complex modeling of objects to be photographed is not needed. The object may be unambiguously characterized by its distance. The camera may track the object and keep the focus set on the object even if the optical axis of the camera is by then pointing at a different object.

### BRIEF DESCRIPTION OF THE DRAWINGS

FIG. 1 shows a specific embodiment of a camera.

FIG. 2 shows a further specific embodiment of a camera.

FIG. 3 shows a further specific embodiment of a camera.

FIG. 4 shows a further specific embodiment of a camera.

### DETAILED DESCRIPTION

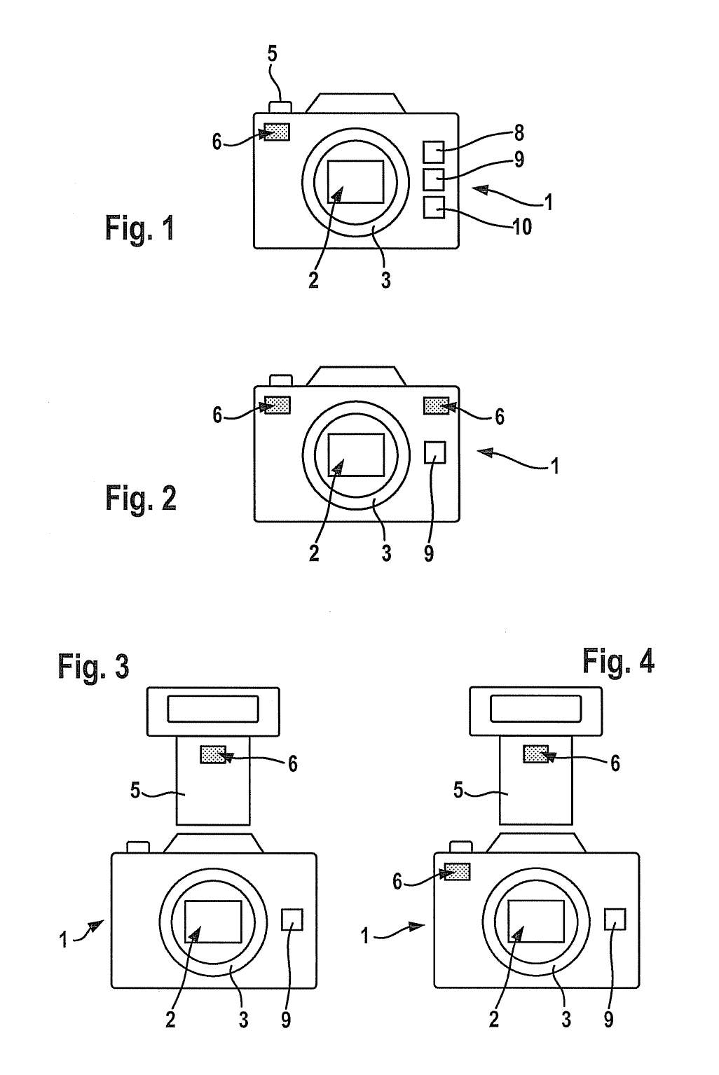

FIG. 1 shows a front view of a first specific embodiment of a camera 1. Camera 1 has a main sensor 2 which is used for recording images. Main sensor 2 may contain a CCD sensor or a CMOS sensor. Main sensor 2 may advantageously capture color images of a scene.

A lens 3 is situated in front of main sensor 2. Lens 3 has an adjustable focus. Camera 1 adjusts lens 3 in such a way that a desired object appears sharply on main sensor 2.

An aperture may be situated in front of main sensor 2. The aperture affects the depth of field. As the opening diameter of the aperture increases (as the f-number decreases), the depth of field decreases. If objects are recorded which are situated at differing distances from the camera; the opening of the aperture is reduced in response. However, this entails a loss of light flux and consequently longer exposure times.

Camera 1 may control the aperture. Here, it is taken into consideration how luminous the objects to be captured are, among other things. It is also taken into consideration whether the objects are situated at different distances from camera 1 and, if applicable, how widely dispersed the various distances are from a mean distance. A method for determining the distance to the individual objects and the related devices are explained below.

A flash 5 may be incorporated in camera 1. Flash 5 is typically triggered simultaneously with the taking of a picture.

An auxiliary sensor 6 is situated at a lateral distance from main sensor 2. Auxiliary sensor 6 and main sensor 2 thus capture a scene from different directions. This results in a stereoscopic image.

The images of main sensor 2, referred to below as first images, and the images of auxiliary sensor 6, referred to below as second images, are supplied to an evaluation device 9 (FIG. 2). Evaluation device 9 compares one of the first images with a corresponding second image captured simultaneously. In this comparison process image points and image objects are ascertained which in the first image are shifted relative to the second image. The shift value is used to ascertain the distance between camera 1 and the object shown in the image object.

The image objects may be classified by how far removed they are from camera 1.

With camera 1 operating semi-automatically, a photographer may select one or several of the image objects. This may be done, for example, by directing the optical axis of main sensor 2 and of the lens onto the object or objects. A button may be pressed, a spoken command may be given, or the camera may remain pointed at the object for a given minimum duration in order to confirm the selection to camera 1. In a further embodiment a pattern recognition system 10, for example a facial recognition system, is provided. The pattern recognition system determines the predefined image objects and offers them to the photographer for selection.

An autofocus device 8 of camera 1 determines an optimal focus on the basis of the ascertained distances to the selected objects. To that end, in one embodiment a mean distance is determined as the arithmetic mean or as the median. The optimal focus corresponds to the mean distance.

The brightness values of the selected objects may be determined from the first image. Based on the brightness values and a preset exposure time a first f-number is determined for the aperture.

So that all selected objects may appear sharply, a required depth of field is determined. For this purpose, a variance of the distances of the selected objects may be utilized. Alternatively, the shortest and the longest distance for the required depth of field are considered. Based on the ascertained depth of field a second f-number is determined.

The aperture may be set by a control device, on the basis of the first and the second f-numbers. In a variant, the aperture is set preferentially to the first f-number. However, the first f-number must be greater than the second f-number. Otherwise, the aperture is set to the second f-number and, if necessary, the exposure time is increased.

The distance measurements to the individual image objects may be stored in a memory. These data may then be utilized for subsequent or further processing of the main image captured by the main sensor. The distance measurements or image data of the auxiliary sensor may be used for three-dimensional reconstruction of the captured objects.

One further embodiment of a camera takes into account an intrinsic movement of the objects. The related image objects change their position in a sequence of first images. Here, the following cases, among others, may occur, and are then evaluated by an evaluation device 9:

An image object remains stationary in successive images of a sequence. Initially these image objects are associated to objects which are not moving relative to camera 1. The related objects may also be situated at a very great distance from camera 1. Any movement of the object or movement of camera 1 relative to the object then results in a change in direction which is so small that it is below the resolution threshold of main sensor 2. Evaluation device 9 differentiates between the two cases with the aid of the distance measurements to the objects as determined above.

The image objects move at the same speed through the image, i.e., by the same absolute value and in the same direction. The movement is in particular independent of the distance of the individual objects from camera 1. Evaluation device 9 associates such a scenario as resulting from a rotary movement of camera 1.

If analysis by evaluation device 9 reveals that image objects from objects previously identified as being distant show a lesser shift in two successive images than image objects of comparatively close objects, a corresponding lateral translational movement of camera 1 is ascertained.

For a selection of image objects, a directional vector of the movement in the image is determined from the two successive images. The directional vectors point toward a point in the image plane. This point is known as the focus of expansion. The expansion point changes as camera 1 continues to move. Evaluation device 9 determines the spatial position of camera 1 from the movement of the expansion point.

Individual objects may demonstrate an intrinsic movement. The moving objects and the non-moving objects demonstrate a different relative speed with reference to camera 1. As a result, the image objects of the intrinsically moving objects have a directional vector which does not point to the expansion focus. On the basis of this deviation, evaluation device 9 may ascertain which objects are moving intrinsically. After determining the trajectory of the camera with the aid of non-moving objects, the spatial trajectory of the image objects may also be determined.

One embodiment provides for a focus to be determined for the next tenths of a second or seconds from the determined spatial trajectory of the objects. Given appropriate computing power in evaluation device 9, the focus may also be determined for shorter time periods and, having commensurate accuracy in the determination of the trajectory, it may also be determined for longer periods. Advance calculation of the focus is particularly useful for compensating for the shutter speed of camera 1.

One further embodiment uses the determined trajectory of selected image objects for image stabilization. In this process an active area of the main sensor may be shifted. In the case of a CCD sensor, a section of the overall sensor surface is activated. In response to the movement of the image object, a different section of the sensor surface is activated.

Auxiliary sensor 6 may be a simple black-and-white sensor or a grayscale sensor. The resolution of auxiliary sensor 6 may be less than that of main sensor 2. The image data of the main sensor may initially be converted into corresponding grayscales, before the distance is determined through comparison of the images.

One specific embodiment provides for using the grayscale values of auxiliary sensor 6 for the exposure measurements. To this end, auxiliary sensor 6 may be provided with a high sensitivity to darkness and/or with high dynamics. One particularly preferred specific embodiment provides for using the brightness values of selected image objects in order to measure brightness. The image objects may be selected as described above with reference to the autofocus system.

FIG. 2 shows a specific embodiment having two auxiliary sensors.

One further specific embodiment of camera 1 uses an auxiliary sensor which is attached to an external flash unit (FIG. 3). Camera 1 has an interface via which the image data of the auxiliary sensor are transferred to evaluation device 9 in camera 1.

One further specific embodiment of camera 1 uses an auxiliary sensor in the casing of camera 1 and a further auxiliary sensor which is attached to an external flash unit (FIG. 4).

Camera 1 may be either a camera 1 for photographing individual images or one for recording a film. Camera 1 may also be either a compact camera or, alternatively, a reflex camera. Camera 1 may also be incorporated in a motor vehicle for monitoring its interior or the surroundings of the motor vehicle. In a further variant, camera 1 is used as a permanently installed or mobile security camera for monitoring purposes.

1-10. (canceled)

11. A camera comprising:
a main sensor to capture a first image of a scene having at least one object;
a lens for the main sensor;
at least one auxiliary sensor situated at a distance from the main sensor, for capturing a second image of the scene having the at least one object at a viewing angle different from that of the main sensor;
an evaluation device for stereoscopic determination of a distance to the at least one object on the basis of the first and second images; and
an autofocus system for setting a focus of the lens in response to the determined distance, or of an exposure setting device for setting an exposure of the main sensor corresponding to the second captured image.

12. The camera according to claim 11, wherein the evaluation device is set up to estimate a trajectory of the object on the basis of sequentially captured first and second images, and the autofocus system sets the focus of the lens on the basis of the estimated trajectory for a given point in time.

13. The camera according to claim 11, further comprising a pattern recognition system to select the at least one object.

14. The camera according to claim 11, wherein the auxiliary sensor is a grayscale sensor.

15. A method for controlling a camera comprising:
parallel capturing at least one first image of a scene with the aid of a main sensor and at least one second image of the scene with the aid of at least one auxiliary sensor at a viewing angle different from that of the main sensor;
associating one of the image objects in the first and second images to an object upon which a focus is set;
determining a distance to the object on the basis of a shift of the associated image object in the first image relative to the second image; and
setting a focus of a lens for the main sensor in response to the determined distance, or setting an exposure of the main sensor corresponding to the second captured image.

16. The method according to claim 15, further comprising:
estimating a movement of the object on the basis of a sequence of at least one of (a) the first images and (b) the second images;
determining a distance of the object at a future point in time on the basis of the estimation of the movement and the determined distance to the object; and
setting the focus to the future distance of the object.

17. The method according to claim 16, wherein the estimation of movement is performed on the first images if these show a higher resolution than the second images, and the estimation of movement is performed on the second images if these show a higher resolution than the first images.

18. The method according to claim 15, wherein a pattern recognition system associates the image object to the object.

19. The method according to claim 15, wherein image data of the auxiliary sensor are stored together with image data of the main sensor.

20. The method according to claim 15, further comprising shifting a detection range of the main sensor in response to an estimated trajectory of the object.
